(19) United States
(12) Patent Application Publication
(10) Pub. No.: US 2007/0008093 A1
(43) Pub. Date: Jan. 11, 2007

(54) Automobile headlight high beam warning system

(76) Inventors: Vincenzo Nigro, White Plains, NY (US); Ann Marie Nigro, White Plains, NY (US)

Correspondence Address: Galasso & Associates, LP, P.O. Box 26503, Austin, TX, 78755-0503, US

(21) Appl. No.: 11/447,335

(22) Filed: Jun. 6, 2006

Related U.S. Application Data
(60) Provisional application No. 60/690,040, filed on Jun. 11, 2005.

(51) Int. Cl. B60Q 1/00

(52) U.S. Cl. 340/436

(57) ABSTRACT

A high beam notification system designed to be mounted on the exterior of a vehicle. The high beam notification system includes a control unit capable of detecting a level of radiant energy consistent with the level of radiant energy generated by a high beam of a conventional headlight. The high beam notification system further includes a visual alert signal device to provide notification to an adjacent vehicle that its high beams are engaged.

### PRIORITY UNDER 35 U.S.C. §119 (e) & 37 C.F.R. §1.78

This nonprovisional application claims priority based upon the following prior United States provisional patent application entitled: Beam Off, Application No.: 60/690,040, filed Jun. 11, 2005, Vincenzo Nigro and Ann M. Nigro, which is hereby incorporated by reference for all purposes.

### FIELD OF THE INVENTION

The present invention relates to a vehicle light warning system, more specifically but not by way of limitation, a vehicle headlight warning system that alerts a driver of an adjacent vehicle to disengage the high beams of the headlight when approaching the vehicle equipped with the headlight warning system from a generally rearward direction.

### BACKGROUND

Millions of individuals travel in their vehicles everyday. The average person spends one and a half hours per day in their vehicle. Approximately thirty percent of a driver's time behind the wheel occurs during the nighttime hours. Driving during the nighttime hours presents a particular set of challenges requiring that drivers maintain a constant awareness of the surroundings. Low visibility at night can combine with poor weather conditions and create an extremely hazardous situation.

One problem that drivers experience at night when traversing a road are the headlights of another vehicle. When another vehicle approaches a driver from the rear or the front of the driver's vehicle, the headlights of the approaching car can create significant temporary vision impairment. As the driver's eyes adjust to the intense light source, the driver is at an increased risk of an accident.

While it is not statute, it is common practice in most areas to alert the driver of a oncoming vehicle to disengage their high beams of the vehicle headlights by briefly flashing the high beams of their own headlights. This notifies the approaching driver that their high beams are currently engaged and that they need to disengage their high beams as they approach the vehicle in order to create a safer driving environment. While this practice is commonly accepted in most areas, there is not a commonly accepted method or system to alert the driver that has approached a vehicle from the rear to disengage their high beams. No current device has been shown to have the ability to alert the driver of a vehicle that has approached another vehicle from the rear that their high beams need to be disengaged in order to reduce glare and the potential for an accident.

Accordingly, there is a need for a system that has the ability to detect and subsequently alert the driver of a vehicle to disengage the high beams of the vehicle upon approaching another vehicle from a rearward direction.

### SUMMARY OF THE INVENTION

It is the object of the present invention to provide a headlight warning system capable of detecting a level of radiant energy consistent with the high beam of conventional headlights that will notify a driver of a rearward approaching vehicle to disengage their high beams of their headlights.

It is a further object of the present invention to provide a high beam headlight warning system that is mounted on the rear area of a vehicle and provides a high beam alert to the driver of another vehicle generally behind the vehicle by utilizing a flashing strobe light.

Another object of the present invention is to provide a high beam headlight warning system that is mounted on the rear of a vehicle that is relatively small in size.

Yet another object of the present invention is to provide a high beam headlight warning system that is relatively inexpensive.

A further object of the present invention is to provide a high beam headlight warning system that signals the driver with their high beams engaged that has approached the vehicle containing the warning system a method of automatically detecting when the high beams have been disengaged.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the headlight high beam warning system attached to the rear portion of a vehicle;

FIG. 2 is a top view of a vehicle approaching a vehicle equipped with the high beam warning system with the high beams engaged;

FIG. 3 is a top view of a vehicle approaching a vehicle equipped with the high beam warning system with the high beams engaged and the high beam warning system providing a visual indication to disengage the high beam;

FIG. 4 is a top view of a vehicle approaching a vehicle equipped with the high beam warning system with the high beams disengaged subsequent to visual notification from the high beam warning system; and

FIG. 5 is a system block diagram illustrating a preferred embodiment of the present invention.

### DETAILED DESCRIPTION

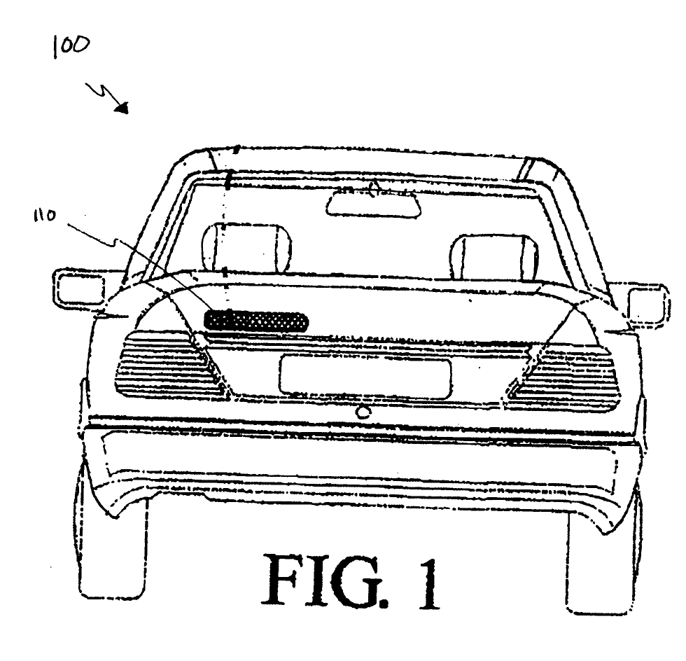

Referring now to the embodiment in FIGS. 1 through 5, and wherein the various elements depicted therein are not necessarily drawn to scale, there is illustrated a preferred embodiment of an high beam notification system 100 constructed according to the principles of the present invention.

The high beam notification system 100 comprises a consolidated control unit 110 that is disposed on the exterior of a vehicle generally on the rear portion of the vehicle. The consolidated control unit 110 has contained therein conventional integrated circuits, photosensors and circuit boards that control the functionality of the consolidated control unit 110. The consolidated control unit 110 further includes a visual alert signal device such as but not limited to a conventional strobe light. Although no specific size of the consolidated control unit 110 is necessary, good results have been achieved with a consolidated control unit 110 that is approximately two inches in height, five inches in length and one-half inches in thickness.

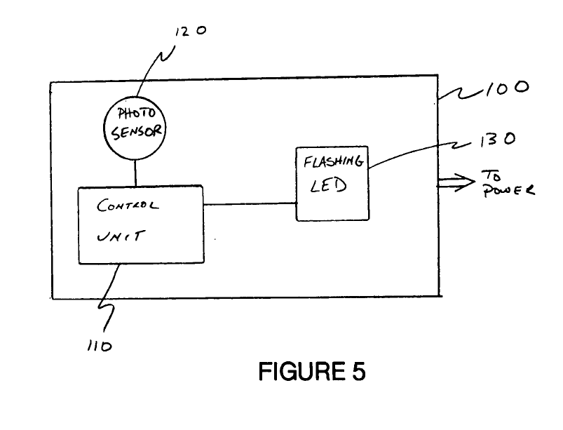

Referring in particular to FIG. 5, there is illustrated an system block diagram of a high beam notification system 100 in accordance with the principles of the present invention. As illustrated, system 100 includes a control unit 110 interconnected between a photosensor 120 and the visual alert signal device 130, which in a preferred embodiment of the present invention includes a single or group of flashing LEDs. In operation photosensor 120 detects incoming light whereupon the controller compares the level of light received at the photosensor 120 with a predetermined level. If the received level of light exceeds the predetermined level, control unit 110 will activate the visual alert signal device 130 to an on mode, whereby it begins to flash. Upon the level of light being received at photosensor 120 drops below the predetermined level, control unit 110 will deactivate the visual alert signal device 130 to an off mode.

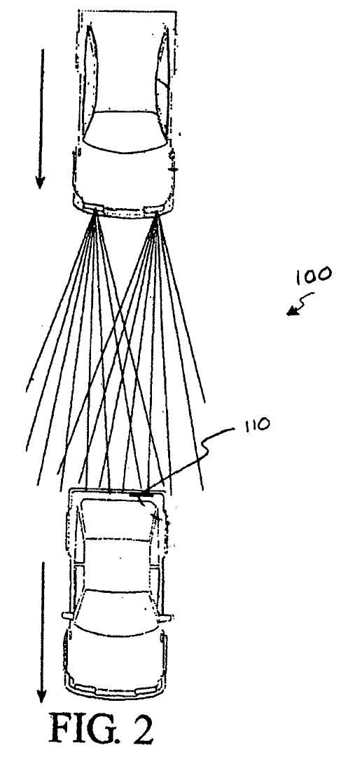

Referring in particular to FIGS. 2-4, the high beam notification system 100 functions to provide visual notification to a vehicle that has approached a vehicle equipped with the high beam notification system 100 that the approaching vehicle has the high beams of the headlights engaged. Subsequent to detection of the high beams of the headlights of an approaching vehicle, the vehicle equipped with the high beam notification system 100 will provide a visual alert signal to alert the approaching vehicle to disengage the-high beams of the headlights.

It is contemplated within the scope of the present invention that the visual alert signal provided by the high beam notification system 100 could utilize a plurality of visual alert signal devices operationally integrated into the high beam notification system 100. More specifically but not by way of limitation, the high beam notification system 100 could utilize a conventional strobe light, the existing tail lights of the vehicle upon which it is mounted, a plurality of led lights, lighted symbol or an electronic marquis type display that would provide visual notification in the form of words such as but not limited to, “turn off high beams”. It is further contemplated that the high beam notification system 100 could utilize audio signals in addition to and/or in conjunction with the visual signal alert device to provide notification of high beam deactivation. Those skilled in the art should recognize that the high beam notification system 100 could be utilized on numerous different types of vehicles such as but not limited to automobiles, trucks or motorcycles.

The consolidated control unit 1 10 contains a conventional photosensor device. A photosensor is an electronic control device that controls a signal output of a system based on the detected illuminance. The photosensor device functions to activate the visual alert signal device through an on/off command based on the intensity of light detected by the photosensor device.

As is known in the art, a photosensor is comprised of a single or plurality of photocells. Photocells are light responding silicon chips that convert incident radiant energy into electrical current. The circuitry disposed within the high beam notification system 100 functions to convert the electrical current generated by the photocell into a controllable signal suitable for activating an operably connected visual alert signal device such as but not limited to a conventional strobe light. The photosensors disposed within the high beam notification system 100 function to monitor the presence and amount of radiant energy generated from approaching vehicles headlights.

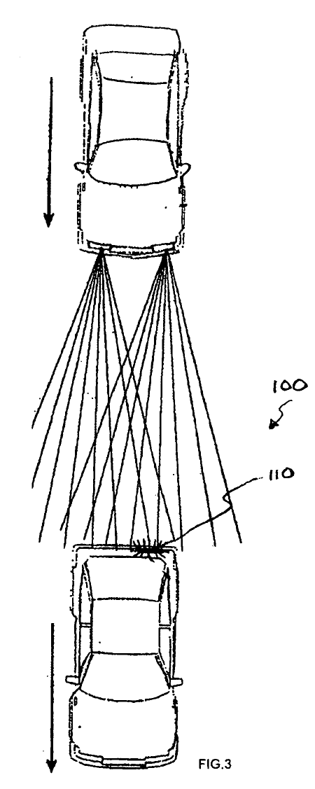

The photosensor is programmed with a radiant energy threshold that is consistent with the radiant energy produced by the high beams of a conventional vehicle headlights as is particularly illustrated in FIG. 2. Subsequent to detection of radiant energy that is consistent with the radiant energy output of the high beams of a vehicles headlights, the photosensor generates a current-through a conventional control wire to activate 'the visual alert signal device disposed within the consolidated control unit 110 as is particularly illustrated in FIG. 3.

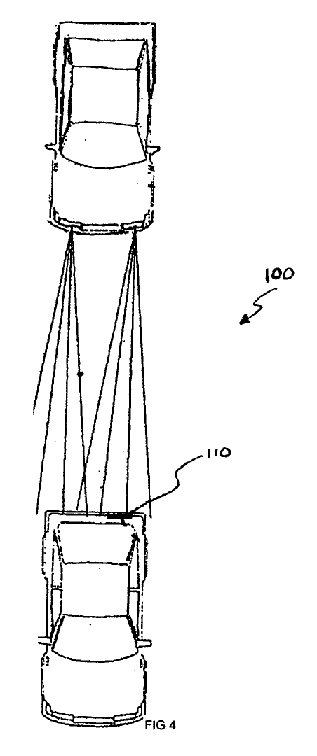

The photosensor continuously provides the current necessary to activate the visual alert signal device during detection of radiant energy that is consistent with the levels of radiant energy that is produced by a conventional high beam of a vehicle's headlight. Referring in particular to FIG. 4, the high beam notification system 100 is deactivated subsequent to diminished levels of radiant energy present adjacent thereto. Photosensor controlled systems can either be an open-loop or close-loop system. The type of system depends on whether or not the photosensor detects illuminance from a light source that the photosensor controls. Although no specific system type is necessary for the high beam notification system 100, good results have been achieved utilizing an open-looped system for the photosensor disposed within the high beam notification system 100.

Ensuing to diminished levels of radiant energy consistent with the levels of radiant energy produced by a high beam of a conventional headlight from an approaching vehicle, the photosensor decreases the current through the conventional control wire in order to deactivate the visual alert signal device. It is further contemplated within the scope of the present invention that the high beam notification system 100 further includes a manually controlled interface that allows the user to adjust the range of radiant energy necessary to activate the visual alert signal device.

While good results have been achieved with a high beam notification system 100 that is disposed on generally the rear portion of a vehicle, those skilled in the art should recognize that the high beam notification system 100 could be utilized on any area of the vehicle to detect high beams of vehicles approaching from a plurality of directions and subsequently provide a visual alert signal to the approaching vehicle to disengage the high beam. It is further contemplated within the scope of the present invention that the high beam notification system 100 could further include a receiving system. It is contemplated that a high beam notification/control system would function to provide a visual alert signal in the presence of a radiant energy commensurate with the radiant energy of a conventional high beam of a vehicle and further operably control the deactivation of the high beam of the headlight with conventional circuitry to provide automatic control of the headlight's high beams of the vehicle that has the high beams engaged.

In this system, the high beam notification system 100 would be operably connected to the circuitry controlling the beams of the vehicle's headlights. Upon sensing the predetermined amount of radiant energy consistent with the high beams of a conventional headlight, the high beam notification system 100 would activate the integrated visual alert signal device. The approaching vehicle would further include a high beam notification/control system. Subsequent to activation of the high beam notification system 100, the high beam notification/control system of the nearby vehicle would process that visual alert signal and produce a signal and distribute to the circuitry of the vehicle to deactivate the vehicle's high beams.

While no specific power source is required for the high beam notification system 100, good results have been achieved utilizing the 12 volt direct current power source of a standard vehicle. Those skilled in the art should recognize that numerous different power sources could be utilized in place of and/or in conjunction with a 12 volt direct current power source. More specifically but not by way of limitation, a renewable metal-hydride or lithium ion power source could be utilized.

It is further contemplated with the scope of the present invention that the visual alert signal could be replaced or used in conjunction with a frequency signal such as but not limited to an RF signal to alert and/or control the engaged high beams of an approaching vehicle. Those skilled in the art should recognize that numerous different colors of visual signals could be utilized. Furthermore, it is contemplated within the scope of the present invention that the high beam notification system 100 could be a plurality of shapes such as but not limited to rectangular.

Referring in particular to FIGS. 1-4, a description of the operation of the high beam notification system 100 is as follows. In use, the high beam notification system 100 is mounted on the rear portion of the vehicle or is integrally mounted to an existing taillight of a vehicle. The high beam notification system 100 is programmed with a threshold level of radiant energy consistent with that of standard high beams of conventional headlights.

During the nighttime hours, the high beam notification system 100 monitors an area adjacent thereto utilizing the photosensors to detect presence of radiant energy. Subsequent to detection of a radiant energy level exceeding the programmed threshold, the high beam notification system 100 activates an integrally mounted visual alert signal device such as but not limited to a strobe or flashing light. The visual alert signal device will remain activated during the presence of radiant energy exceeding the programmed threshold. Ensuing to diminished levels of radiant energy adjacent to the high beam notification system 100, the high beam notification system 100 will deactivate the visual alert signal device.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A high beam notification system mounted on a vehicle, comprising:
a control unit, said control unit generally being disposed on the exterior of said vehicle, said control unit capable of detecting radiant energy consistent with the levels of radiant energy generated by a high beam of a conventional headlight of a vehicle; and
a visual alert signal device, said visual alert signal device integrally mounted within said control unit, said visual alert signal device operable to be activated by said control unit in response to the detection of said of radiant energy exceeding a predetermined level.

2. The high beam notification system as recited in claim 1, wherein said visual alert signal device further includes a plurality of LED lights.

3. The high beam notification system as recited in claim 1, wherein said visual alert signal device further includes the brake lights of said vehicle.

4. The high beam notification system as recited in claim 2, and further includes a direct current power source to provide power to said high beam notification system.

5. The high beam notification system as recited in claim 4, wherein said visual alert signal device generates a flashing visual pattern in the presence of radiant energy consistent with the radiant energy generated by a high beam of a conventional headlight.

6. The high beam notification system as recited in claim 5, wherein said control unit further includes a manual interface for varying the threshold of radiant energy necessary for activation of said visual alert signal device.

7. A notification system mounted on a vehicle, the notification system configured to detect the high beams of conventional headlights of a nearby vehicle, comprising:
a control unit, said control unit generally being disposed on the exterior of said vehicle, said control unit further being located on the rear portion of said vehicle, said control unit capable of detecting a first and a second level of radiant energy adjacent thereto; and
a visual alert signal device, said visual alert signal device being operable between an on mode and an off mode, said visual alert signal device switched to said on mode in response to said control unit detecting at least the second level of radian energy.

8. The high beam notification system as recited in claim 7, wherein said first level of radiant energy is consistent with the low beams of conventional headlights.

9. The high beam notification system as recited in claim 8, wherein said second level of radiant energy is consistent with the high beams of conventional headlights.

10. The high beam notification system as recited in claim 7, and further including a 12 volt direct current power source.

11. The high beam notification system as recited in claim 10, wherein said visual alert signal device includes a plurality of LED lights such that said plurality of LED lights emit light when said visual alert signal device is in said on mode.

12. The high beam notification system as recited in claim 11, wherein said high beam notification system further includes a manual interface for adjusting the level of radiant energy required to be present before said control unit determines said second level of radiant energy is present.

13. The high beam notification system as recited in claim 12, wherein said visual alert signal device generates a flashing pattern when in said on mode.

14. The high beam notification system as recited in claim 13, herein said control unit is approximately 2 inches in height by approximately 5 inches in length and approximately 0.5 inches in thickness.

15. A headlight notification system mounted on a vehicle configured to detect the high beams of a conventional headlight of a nearby vehicle, comprising:
a control unit, said control unit generally being disposed on the exterior of said vehicle, said control unit being rectangular in shape, said control unit further being located on the rear portion of said vehicle, said control unit capable of detecting a first level of radiant energy, said first level of radiant energy consistent with the level of radiant energy produced by a low beam of a conventional headlight, said control unit further being capable of detecting a second level of radiant energy, said second level of radiant energy being consistent with the level of radiant energy produced by the high beams of a conventional headlight, said control unit configured to monitor the area generally adjacent thereto; and
a visual alert signal device, said visual alert signal device disposed within said control unit, said visual alert signal device having a first and a second position, said first position being the position whereby the visual alert signal device is deactivated, said second position being the position whereby the visual alert signal device is activated subsequent to the detection of said second level of radiant energy.

16. The high beam notification system as recited in claim 15, wherein said high beam notification system further includes a twelve volt direct current power source.

17. The high beam notification system as recited in claim 16, wherein said visual alert signal device comprises a plurality of LED lights.

18. The high beam notification system as recited in claim 17, wherein said visual alert signal device generates a flashing visual pattern in the presence of radiant energy consistent with said second level of radiant energy.

19. The high beam notification system as recited in Maim 18, wherein said high beaus notification system further includes a manual interface for adjusting the level of radiant energy required to be present before said control unit determines said second level of radiant energy is present.

20. The high beam notification system as recited in claim 13, wherein said control unit is 2 inches in height by 5 inches in length and 0.5 inches in thickness.
